(19) United States
(12) Patent Application Publication
(10) Pub. No.: US 2008/0076093 A1
(43) Pub. Date: Mar. 27, 2008

(54) Removable plates grillz

(75) Inventors: Kyung Tae Kim, Dallas, TX (US); Young Kim, Dallas, TX (US)

Correspondence Address: Kyung T. Kim, Suite 240, 3102 Maple Avenue, Dallas, TX, 75201, US

(73) Assignee: O.J. Trading, Inc., Dallas, TX (US)

(21) Appl. No.: 11/524,575

(22) Filed: Sep. 21, 2006

(51) Int. Cl. A61C 13/08

(52) U.S. Cl. 433/206

(57) ABSTRACT

Decorative elements in the form of removable personalized plates made of dentistry metal (nickel free Rhodium, gold, silver, chromium, cobalt, titanium, or similar metals) with imbedded stone pattern designs, thereby producing a particular effect on a user's teeth, that are applied in a removable mode by pressing the individual plates with horseshoe-shaped fastening brackets onto a specially design frame with upward serpentine-shaped prongs with outward protruding center depressions or dimples pressed against the interior of the fastening brackets to secure in place multiple ornamental plates.

### CROSS-REFERENCE TO RELATED APPLICATIONS

U.S. patent application Ser. No. 11/491,641; Title: Silicone-Thermoplastic Molded Grillz; Filing date: Jul. 24, 2006.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

1. Field of the Invention

In general, the invention relates to a method of applying decorative elements in the form of removable plates made of metal with stone designs to a frame of metal that are secured in place by horseshoe-shaped fastening brackets inserted onto the upper serpentine-shaped prongs with center depressions or dimples protruding outward from the frame. The user would have a choice of various styles of dentistry metal removable plates with stone patterns, which allows personalization to additionally embody the characteristics of a custom fitted assembly device for a teeth set.

The frame also holds by lower tightening prongs a silicone-thermoplastic material member molded by heating to certain temperatures to fit a particular person's group of upper or lower teeth set. The silicone-thermoplastic molded member being held in place by tightening prongs of the frame is incorporated from U.S. patent application Ser. No. 11/491,641.

2. Description of the Prior Art

The decorating of teeth or an entire denture of a human by adding or attaching some type of ornamental device to call attention or for entertainment purposes have become popular among certain people in the entertainment industry and people who desire to associate with certain types of social and cultural environments. Some decorative devices for human teeth consist of adhering a decorative element to a vestibule surface of a tooth or vestibule surfaces of a group of teeth in the form of a plate made of metal or plastic hereby producing an attraction on a user's teeth or by specially designed frames that fit over several teeth to hold in place a decoration fixed to the vestibule surface. See for example U.S. patent application Ser. No. 11/274,251

The prior art under U.S. patent application Ser. No. 11/491,641 is an individualized and customized method to hold an assembly for upper and lower teeth decoration on a removable basis from the teeth and mouth. The prior art is placed into the mouth and with the user's teeth pressed into the silicone-thermoplastic material an exact mold of the user's teeth is created in the silicone-thermoplastic material. The thermoplastic material is moldable, settable and conforms to a user's intra-oral structures when subject to heat and bite pressure.

The present invention relates to removable personalized ornamental plates that are attached to the outer portion of the frame assembly of the prior art under U.S. patent application Ser. No. 11/491,641.

The present invention does not have any application as a sports guard or as an orthodontic appliance. With the present invention, there are no risks to health or hygiene of the user's mouth, since the assembly can be easily removed at any time.

### BRIEF SUMMARY OF THE INVENTION

The present invention relates to a method for securing removable decorative or ornamental plates made of dentistry metal with outward plating of nickel free Rhodium, silver, gold, chromium, cobalt, titanium, or similar metals imbedded with stone patterns to upward facing, serpentine-shaped prongs of a specially designed frame by using horseshoe-shaped fastening brackets with groves to fit the upward prongs of the frame and with center depressions or dimples protruding outward against the inserted brackets of the decorative plates.

The invention is incorporating the silicone-thermoplastic member features of U.S. patent application Ser. No. 11/491,641, filing date Jul. 24, 2006, to secure the complete frame assembly to the user's teeth set. The frame uses downward projecting tightening prongs to hold a silicone-thermoplastic member into the frame that is molded to a user's upper or lower teeth set.

### BRIEF DESCRIPTION OF THE SEVERAL VIEWS OF THE DRAWING

These and other objects of the present invention will become evident from the following illustrations:

FIG. 1 is an interior representation of the specially designed frame with the backside of the decorative plates inserted into the six (6) upward serpentine-shaped prongs.

FIG. 2 is an interior representation of a decorative plate illustrating the horseshoe-shaped fastening bracket element and inner grove.

FIG. 3 is an interior representation of decorative plates being inserted into the upper serpentine-shaped prongs of the frame assembly and illustrating the center depression or dimple that protrudes outward within the grove and bracket to provide the tension to hold the decorative plates stationary on the frame.

FIG. 4 is a representation of the decorative plates positioned illustrating the decorative face elements and the horseshoe-shaped fastening bracket on the reverse side and the specially designed frame with serpentine-shaped prongs prior to inserting the decorative plates.

FIG. 5 is a representation of the specially designed frame prior to the insertion of the decorative plates and illustrating the silicone-thermoplastic member inserted into the frame and held by the lower tightening prongs prior to the heat molding application as incorporated from U.S. patent application Ser. No. 11/491,641.

### DETAILED DESCRIPTION OF THE INVENTION

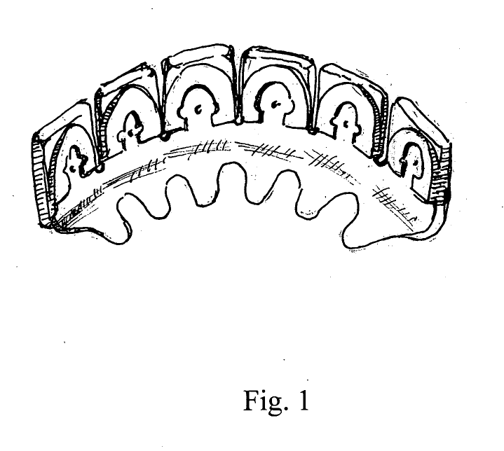

FIG. 1 is an interior representation of the specially designed frame with the backside of six (6) decorative plates inserted into the six (6) upward serpentine-shaped prongs and the lower extending six (6) tightening prongs. FIG. 1 illustrates the interior of the assembly with the decorative plates, showing the side of the horseshoe-shaped fastening brackets inserted into the supporting frame with the center placed depression or dimple in the bracket to hold in place the decorative plates.

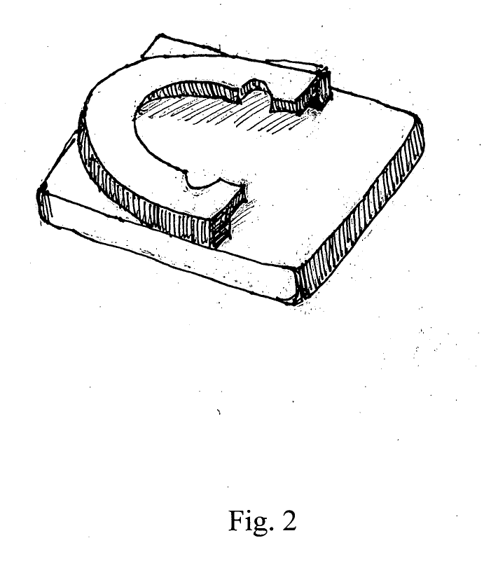

FIG. 2 illustrates a single decorative plate with an interior representation showing the horseshoe-shaped fastening bracket element. The bracket has an inside track or grove to receive and hold firmly the serpentine-shaped prongs of the upper portion of the frame.

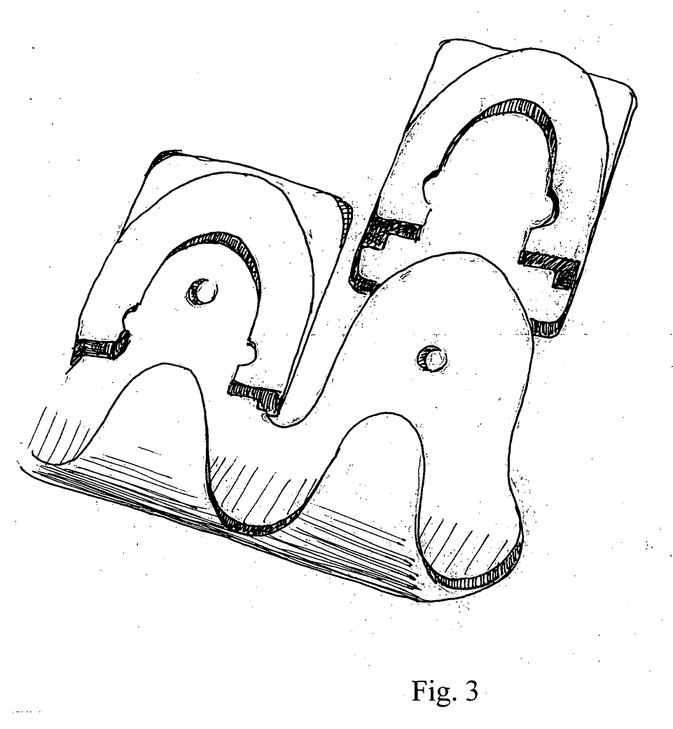

FIG. 3 illustrates the insertion of the upper serpentine shaped prongs of the frame assembly into the inside track or grove of the horseshoe-shaped fastening bracket of the decorative plate and illustrates the center depression or dimple that protrudes outward against the bracket side of the decorative plate to provide the tension to hold the plates stationary on the frame.

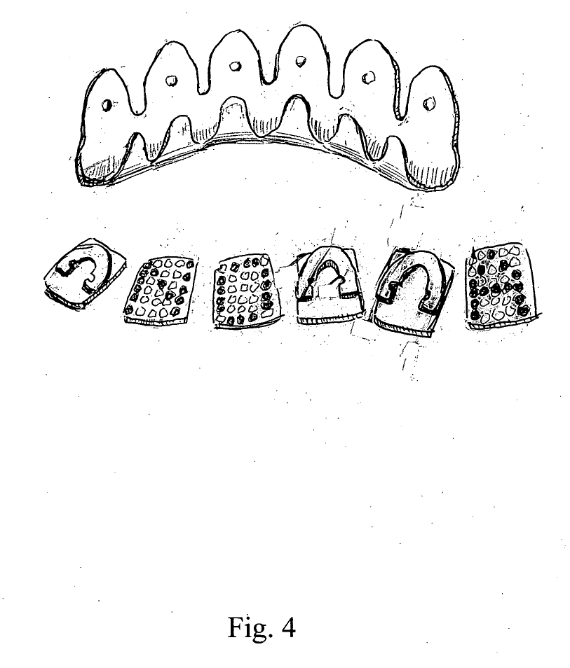

FIG. 4 is a representation of both sides of the decorative plates positioned illustrating the decorative face elements consisting of dentistry metal with outward plating of nickel free Rhodium, silver or gold imbedded with multicolor stone patterns of letters or other designs and on the reverse side of the plates the horseshoe-shaped fastening brackets. FIG. 4 illustrates the specially designed serpentine-shaped frame with the centered depressions or dimples to hold the plates.

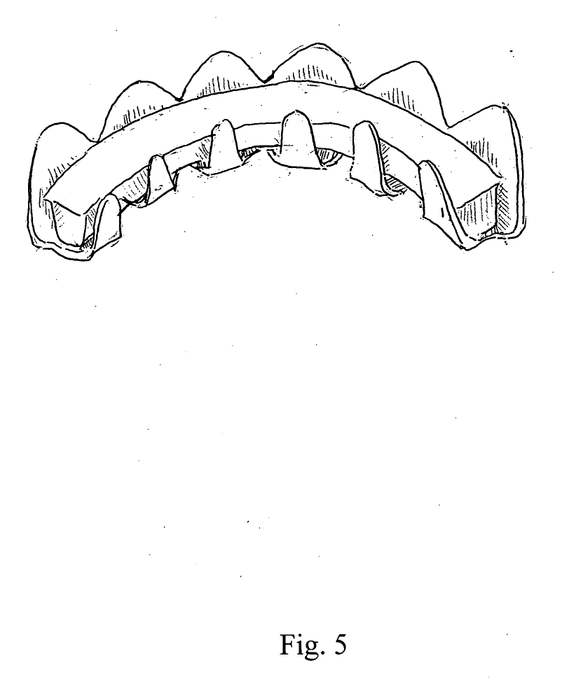

FIG. 5 is a representation of the specially designed frame prior to the insertion of the decorative plates and illustrating the serpentine-shaped upper portion of the frame and the lower tightening prongs holding the silicone-thermoplastic member prior to the heat molding application as incorporated from U.S. patent application Ser. No. 11/491,641.

Prior to the placement of the decorative plates to the frame, the silicone member and frame assembly, as illustrated in FIG. 5, is first prefitted to the user's mouth by shaping it to conform to the general shape of the teeth set.

Then, the assembly is heated by immersing in hot water to a desired softening temperature, which will change the silicone material from a non-transparent color to a transparent color. The silicone member will soften sufficiently to be molded about the teeth at a temperature in the range from about 120° F. to about 160° F. and which, upon cooling below this range of temperature and particularly to normal atmospheric or internal mouth temperatures, will permanently retain an accurate impression of the teeth.

The assembly is quickly inserted into the user's mouth and the user presses the thermoplastic material to form the impressions of the intra-oral structures. The pressure is maintained for 2 to 3 minutes while the thermoplastic material sets. The assembly is then removed from the mouth and immersed in cold water to fix the impressions.

As it cools to body temperature in the mouth of the user, it hardens in the shape that it is forced into and is therefore individualized and customized to snugly fit for the user adhering to the upper and/or lower teeth.

The finished device will tend to cling tightly about the teeth, so that it will not be dislodged easily in use but may be readily removed and re-inserted as desired.

Following the preparation of the tightening prongs and the molding of the silicone-thermoplastic insert, the decorative plates are then inserted as illustrated in FIG. 3. Each decorative plate may be removed and changed at any time.

The invention claimed is:

1. A decorative assembly for human teeth, comprising:
ornamental removable plates made of dentistry metal imbedded with personalized stone patterns secured in a specially designed frame.

2. The method of claim 1, wherein the metal frame has serpentine-shaped prongs in the upper portion of the frame.

3. The method according to claim 2, wherein using horseshoe-shaped fastening brackets with groves to fit the serpentine-shaped prongs.

4. The method according to claim 3, wherein the serpentine-shaped prongs with center depressions or dimples protruding outward against the interior of the horseshoe-shaped fastening brackets.
